(19) United States
(12) Patent Application Publication
(10) Pub. No.: US 2014/0203660 A1
(43) Pub. Date: Jul. 24, 2014

(54) POWER SUPPLY APPARATUS, CONTROL METHOD THEREOF, AND POWER SUPPLY SYSTEM

(71) Applicant: CANON KABUSHIKI KAISHA, Tokyo (JP)

(72) Inventor: Yukihiro Adachi, Machida-shi (JP)

(73) Assignee: CANON KABUSHIKI KAISHA, Tokyo (JP)

(21) Appl. No.: 14/149,304

(22) Filed: Jan. 7, 2014

(30) Foreign Application Priority Data
Jan. 18, 2013 (JP) 2013-007841

(51) Int. Cl. H04B 5/00; H02J 7/02

(52) U.S. Cl. CPC H04B 5/0037; H02J 7/025
USPC 307/104

(57) ABSTRACT

A power supply apparatus comprises a power supply unit which wirelessly supplies power; a communication unit which transmits a predetermined instruction to request transmission of identification information; and a control unit which, when the predetermined instruction is transmitted to a predetermined device, controls to transmit the identification information of the predetermined device to the power supply apparatus after a first time elapses, wherein when the predetermined instruction is transmitted to a power receiving apparatus different from the predetermined device, the control unit controls to transmit the identification information of the power receiving apparatus to the power supply apparatus after a second time longer than the first time elapses.

### BACKGROUND OF THE INVENTION

1. Field of the Invention

The present invention relates to a power supply apparatus that controls power to be wirelessly supplied to a power receiving apparatus, and a power supply system.

2. Description of the Related Art

There is known a wireless power supply system including a power receiving apparatus and a power supply apparatus that wirelessly supplies power to the power receiving apparatus without intervening a connector or a cable. As an example of such a noncontact power supply system, a system is known, which magnetically couples a power supply apparatus and a power receiving apparatus in accordance with a specific frequency and causes the power supply apparatus to transmit power to the power receiving apparatus by magnetic resonance. In this case, the power supply apparatus controls the power to be supplied to the power receiving apparatus by magnetic resonance in accordance with power acceptable by the power receiving apparatus.

For example, a frequency band of 13.58 MHz±7 kHz in the ISM (Industry-Science-Medical) band is known to be used to perform magnetic resonance. This frequency is used for various application purposes such as authentication of an IC card such as Felica®.

The power acceptable by the IC card is smaller than the power acceptable by the power receiving apparatus coping with magnetic resonance. For this reason, if the IC card exists near the power supply apparatus during power supply from the power supply apparatus to the power receiving apparatus, the power supply apparatus may supply, to the IC card, power larger than that acceptable by it. In this case, a failure may occur in the IC card.

To prevent this, a power receiving apparatus is known, which changes the frequency in accordance with a change in the temperature when the internal temperature has risen due to excessive power supply from the power supply apparatus and decreases the value of a current flowing through (for example, Japanese Patent Laid-Open No. 2008-035405).

In the conventional power receiving apparatus, however, the excessive power is continuously supplied from the power supply apparatus to the IC card during the time after excessive power supply from the power supply apparatus has started until the internal temperature of the IC card rises. For this reason, the power supplied from the power supply apparatus during the time until the internal temperature of the IC card rises may cause a failure in the IC card. Note that this problem arises in a power receiving apparatus other than the IC card as well.

### SUMMARY OF THE INVENTION

The present invention has been made in consideration of the aforementioned problems and realizes a technique of controlling power to be supplied to a power receiving apparatus not to supply excessive power to the power receiving apparatus, thereby preventing a failure in it.

In order to solve the aforementioned problems, the present invention provides a power supply apparatus comprising: a power supply unit configured to wirelessly supply power; a communication unit configured to transmit a predetermined instruction to request transmission of identification information; and a control unit configured to, when the predetermined instruction is transmitted to a predetermined device, control to transmit the identification information of the predetermined device to the power supply apparatus after a first time elapses, wherein when the predetermined instruction is transmitted to a power receiving apparatus different from the predetermined device, the control unit controls to transmit the identification information of the power receiving apparatus to the power supply apparatus after a second time longer than the first time elapses.

In order to solve the aforementioned problems, the present invention provides a power supply system which supplies power to a power receiving apparatus existing near a power supply apparatus, the power supply apparatus comprising: a power supply unit configured to wirelessly supply power; a communication unit configured to transmit a predetermined instruction to request transmission of identification information; and a control unit configured to, when the predetermined instruction is transmitted to a predetermined device, control to transmit the identification information of the predetermined device to the power supply apparatus after a first time has elapsed, wherein when the predetermined instruction is transmitted to a power receiving apparatus different from the predetermined device, the control unit controls to transmit the identification information of the power receiving apparatus to the power supply apparatus after a second time longer than the first time has elapsed, and the power receiving apparatus comprising a communication unit configured to receive the predetermined instruction from the power supply apparatus and transmit the identification information to the power supply apparatus at a timing according to the predetermined instruction.

In order to solve the aforementioned problems, the present invention provides a control method of a power supply apparatus which wirelessly supplies power to a power receiving apparatus, the method comprising: a communication step of transmitting a predetermined instruction to request the power receiving apparatus to transmit identification information; and a control step of, when the predetermined instruction is transmitted to a predetermined device, controlling to transmit the identification information of the predetermined device to the power supply apparatus after a first time has elapsed, wherein when the predetermined instruction is transmitted to a power receiving apparatus different from the predetermined device, control is performed in the control step to transmit the identification information of the power receiving apparatus to the power supply apparatus after a second time longer than the first time has elapsed.

Further features of the present invention will become apparent from the following description of exemplary embodiments (with reference to the attached drawings).

### BRIEF DESCRIPTION OF THE DRAWINGS

FIG. 1 is a block diagram showing an example of a power supply system according to the first embodiment;

FIGS. 2A to 2D are views showing examples of the form of the power supply system according to the first embodiment;

FIG. 3 is a flowchart showing an example of communication control processing performed by a power supply apparatus according to the first embodiment;

FIG. 4 is a sequence chart showing exchange in communication between the power supply apparatus and a device in the power supply system according to the first embodiment;

FIG. 5 is a flowchart showing an example of identification processing performed by the power supply apparatus according to the first embodiment;

FIG. 6 is a view showing an example of an identification table recorded in the power supply apparatus according to the first embodiment; and

FIG. 7 is a flowchart showing an example of communication control processing performed by the power supply apparatus according to the first embodiment.

### DESCRIPTION OF THE EMBODIMENTS

The present invention will now be described using the first embodiment as an example. Note that the present invention is not limited to the first embodiment.

### First Embodiment

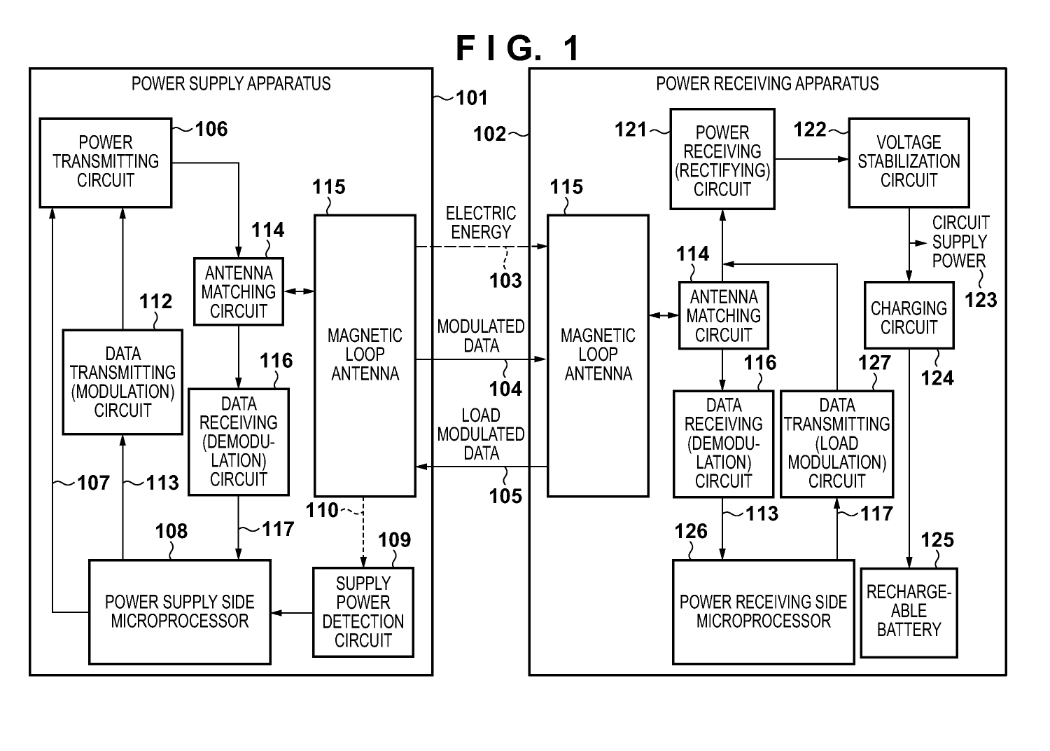

FIG. 1 shows a power supply system according to the first embodiment. The power supply system according to the first embodiment will be described below with reference to FIG. 1.

Referring to FIG. 1, a power supply apparatus 101 wirelessly supplies power to a power receiving apparatus 102. Between the power supply apparatus 101 and the power receiving apparatus 102, the power supply apparatus 101 performs one-way or bidirectional data communication with the power receiving apparatus 102. The power supply apparatus 101 starts power supply to the power receiving apparatus 102 after authenticating it. Transmission power generated by a power transmitting circuit 106 passes through an antenna matching circuit 114, and is converted into electric energy 103 via a magnetic loop antenna 115 and emitted into the space. Note that power 110 that is part of the transmission power generated by the power transmitting circuit 106 is detected by a supply power detection circuit 109 and input to a power supply side microprocessor 108 as a transmission power level. The supply side microprocessor 108 then controls the transmission power of the power transmitting circuit 106 via a transmission power control signal 107 in accordance with the transmission power level.

The power supply side microprocessor 108 performs bidirectional communication with the power receiving apparatus 102 independently of power transmitting. Data 113 from the power supply side causes a data transmitting (modulation) circuit 112 to superpose modulated data 104 on the electric energy 103 by amplitude modulation (AM) and transmit it.

The data transmitted to the power receiving apparatus 102 is received by the magnetic loop antenna 115, input to a data receiving (demodulation) circuit 116 via the antenna matching circuit 114, and demodulated by the data receiving (demodulation) circuit 116. The data demodulated by the data receiving (demodulation) circuit 116 is input to the power supply side microprocessor 108 as data 117 from the power receiving side. Note that this signal is generated by load modulation from the power receiving side. Load modulation from the power receiving side indicates communication performed when the power receiving apparatus 102 is located in proximity to the power supply apparatus 101 and operates its internal circuits using the energy supplied from the power supply apparatus 101.

The spatially transmitted electric energy 103 is excited by the magnetic loop antenna 115 of the power receiving apparatus 102, passes through the antenna matching circuit 114, and is converted into DC by a power receiving (rectifying) circuit 121. The electric energy 103 converted into the DC passes through a voltage stabilization circuit 122 and changes to circuit supply power 123 to be supplied to the data communication circuit on the side of the power supply apparatus 101. Note that the spatially transmitted electric energy 103 also passes through the voltage stabilization circuit 122 and is used by a charging circuit 124 as power to charge a rechargeable battery 125.

On the other hand, the modulated data 104 transmitted from the power supply apparatus 101 is received by the magnetic loop antenna 115 and passes through the antenna matching circuit 114, like the electric energy 103, and is then input to the data receiving (demodulation) circuit 116. The modulated data 104 is input from the data receiving (demodulation) circuit 116 to a power receiving side microprocessor 126 as the data 113 from the power transmitting side.

The data 117 from the power receiving side is modulated by a data transmitting (load modulation) circuit 127 and transmitted to the power supply apparatus 101. In this case, however, the power receiving apparatus 102 does not generate a high frequency (carrier) used to spatially transmit the data 117 from the power receiving side to the power supply apparatus 101. When the electric energy 103 is being received from the power supply apparatus 101, the power receiving apparatus 102 performs amplitude modulation (AM) of the electric energy 103 from the power supply side by changing the load included in the data transmitting (load modulation) circuit 127 in synchronism with the value of the data 117 from the power receiving side.

As described above, the communication between the power supply apparatus 101 and the power receiving apparatus 102 is implemented by using the electric energy 103 supplied from the power supply apparatus 101 to the power receiving apparatus 102 and amplitude-modulating the electric energy 103 on each of the power transmitting side and the power receiving side. The frequency used by the power supply apparatus 101 and the power receiving apparatus 102 when they communicate is 13.56 MHz±7 kHz in the ISM band.

In a state in which magnetic resonance is performed between the power supply apparatus 101 and the power receiving apparatus 102, the frequency used by the power supply apparatus 101 and the power receiving apparatus 102 when the power supply apparatus 101 supplies power to the power receiving apparatus 102 is also 13.56 MHz±7 kHz in the ISM band.

Note that 13.56 MHz±7 kHz in the ISM band is the frequency used in communication between an IC card and a reader/writer. Note that the communication between the power supply apparatus 101 and the power receiving apparatus 102 is communication complying with the NFC (Near Field Communication) standards.

The power receiving apparatus 102 can be, for example, an image capturing apparatus such as a digital still camera or a digital video camera. The power receiving apparatus 102 may also be a mobile apparatus such as a smartphone or mobile phone. The power receiving apparatus 102 may also be a TV or an automobile.

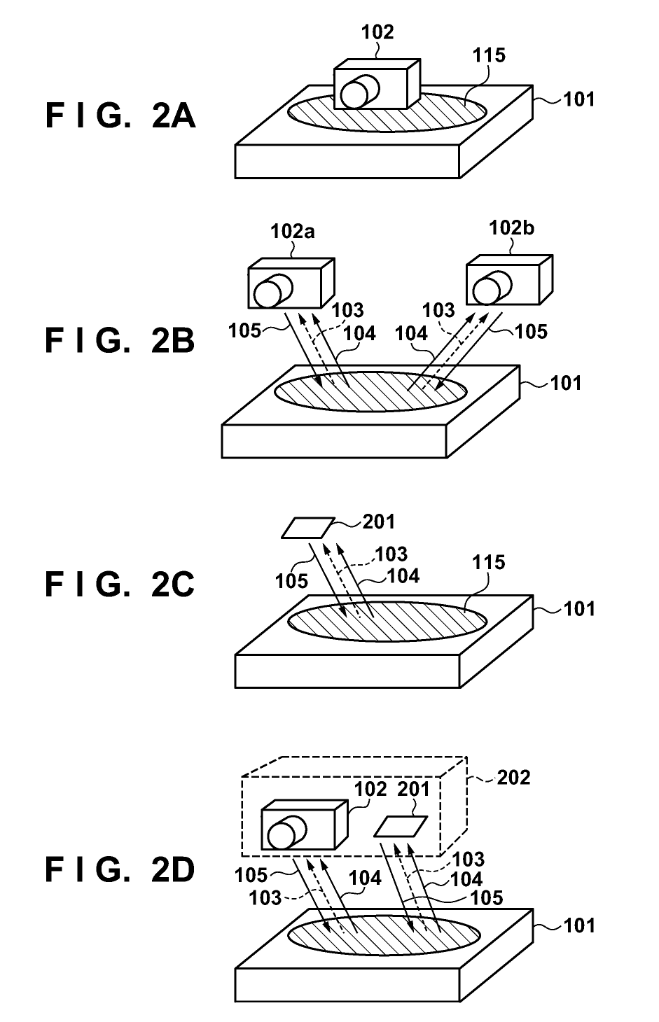

FIGS. 2A to 2D show the form of the power supply system when the power receiving apparatus 102 exists near the power supply apparatus 101.

In the power supply system shown in FIGS. 2A to 2D, when the power receiving apparatus 102 is placed on the power supply apparatus 101, the power supply apparatus 101 starts authentication of the power receiving apparatus 102, and when the authentication of the power receiving apparatus 102 is completed, starts wireless power supply to the power receiving apparatus 102.

FIG. 2A shows a state in which one power receiving apparatus 102 is placed on the power supply apparatus 101. In this case, to authenticate the power receiving apparatus 102, the power supply apparatus 101 transmits the electric energy 103 on which the data 104 from the power supply side is superposed to the power receiving apparatus 102. In this case, the power supply apparatus 101 receives, from the power receiving apparatus 102, data (load modulation) 105 from the power receiving side, thereby completing authentication of the power receiving apparatus 102. After that, the power supply apparatus 101 controls the electric energy 103 to be supplied to the power receiving apparatus 102 in accordance with power acceptable by the power receiving apparatus 102. In this case, the power supply apparatus 101 controls the electric energy 103 to be supplied to the power receiving apparatus 102 such that it becomes larger than the electric energy 103 on which the data 104 from the power supply side is superposed and smaller than the maximum power acceptable by the power receiving apparatus 102.

FIG. 2B shows a state in which a power receiving apparatus 102a and a power receiving apparatus 102b, which are a plurality of power receiving apparatuses, are placed on the power supply apparatus 101. In this case, the power supply apparatus 101 communicates with the power receiving apparatuses 102a and 102b and identifies them. When the power receiving apparatuses 102a and 102b are identified, the power supply apparatus 101 selects one of them. To authenticate the selected power receiving apparatus, the power supply apparatus 101 transmits the electric energy 103 on which the data 104 from the power supply side is superposed to the selected power receiving apparatus. In this case, the power supply apparatus 101 receives, from the selected power receiving apparatus, the data (load modulation) 105 from the power receiving side, thereby completing authentication of the selected power receiving apparatus. After that, the power supply apparatus 101 controls the electric energy 103 to be supplied to the selected power receiving apparatus in accordance with power acceptable by the selected power receiving apparatus. In this case, the power supply apparatus 101 controls the electric energy 103 to be supplied to the selected power receiving apparatus such that it becomes larger than the electric energy 103 on which the data 104 from the power supply side is superposed and smaller than the maximum power acceptable by the selected power receiving apparatus. Note that the power supply apparatus 101 controls not to supply the electric energy 103 to the unselected power receiving apparatus.

Note that the power supply apparatus 101 selects one of the power receiving apparatuses 102a and 102b in accordance with a remaining capacity of a battery or an instruction from the user. Alternatively, the power supply apparatus 101 may select one of the power receiving apparatuses 102a and 102b in accordance with whether power supply has been done previously.

FIG. 2C shows a state in which not the power receiving apparatus 102 shown in FIG. 1 but an IC card 201 is placed on the power supply apparatus 101. In this case, the power supply apparatus 101 communicates with the IC card 201 and identifies it. When the IC card 201 is identified, the power supply apparatus 101 limits the output of the electric energy 103 not to supply excessive power to the IC card 201. For example, in this case, the power supply apparatus 101 stops output of the electric energy 103 until the IC card 201 is removed from the power supply apparatus 101. In this case, the power supply apparatus 101 controls the electric energy 103 such that it becomes smaller than the electric energy 103 on which the data 104 from the power supply side is superposed until the IC card 201 is removed from the power supply apparatus 101.

Note that the power acceptable by the IC card 201 is smaller than the power acceptable by the power receiving apparatus 102 as shown in FIG. 1. The IC card 201 uses 13.56 MHz±7 kHz in the ISM band as the frequency band for communication.

FIG. 2D shows a state in which the power receiving apparatus 102 and the IC card 201 are simultaneously placed on the power supply apparatus 101. In this case, for example, the power receiving apparatus 102 and the IC card 201 are stored in the storage 202 such as a carrying case or a pouch, and the storage 202 is placed on the power supply apparatus 101. In this case, the power supply apparatus 101 communicates with the power receiving apparatus 102 and the IC card 201 and identifies the IC card 201. When the IC card 201 is identified, the power supply apparatus 101 limits the output of the electric energy 103 not to supply excessive power to the IC card 201, as in FIG. 2C.

Referring to FIG. 2D, the power supply apparatus 101 needs to quickly identify the IC card 201 and limit the output of the electric energy 103 not to supply excessive power to the IC card 201 and prevent a failure in the IC card 201. In FIG. 2D, both the frequency band used for the communication with the power receiving apparatus 102 and that used for the communication with the IC card 201 are 13.56 MHz±7 kHz. Hence, to correctly identify the power receiving apparatus 102 and the IC card 201, the power supply apparatus 101 cannot simultaneously perform the communication with the power receiving apparatus 102 to identify the power receiving apparatus 102 and the communication with the IC card 201 to identify the IC card 201. The power supply apparatus 101 needs to perform the communication with the power receiving apparatus 102 to identify the power receiving apparatus 102 and the communication with the IC card 201 to identify the IC card 201 with a time-series shift.

However, the power supply apparatus 101 cannot control which one of the communication with the power receiving apparatus 102 to identify the power receiving apparatus 102 and the communication with the IC card 201 to identify the IC card 201 should be performed preferentially. For this reason, the power supply apparatus 101 may perform the communication with the IC card 201 to identify the IC card 201 after the communication with the power receiving apparatus 102 to identify the power receiving apparatus 102. In addition, if the power supply apparatus 101 simultaneously performs the communication with the power receiving apparatus 102 to identify the power receiving apparatus 102 and the communication with the IC card 201 to identify the IC card 201, collision occurs, and the power supply apparatus 101 cannot identify the power receiving apparatus 102 and the IC card 201. Hence, the power supply apparatus 101 needs to perform the communication with the power receiving apparatus 102 to identify the power receiving apparatus 102 and the communication with the IC card 201 to identify the IC card 201 again, and identification of the IC card 201 delays.

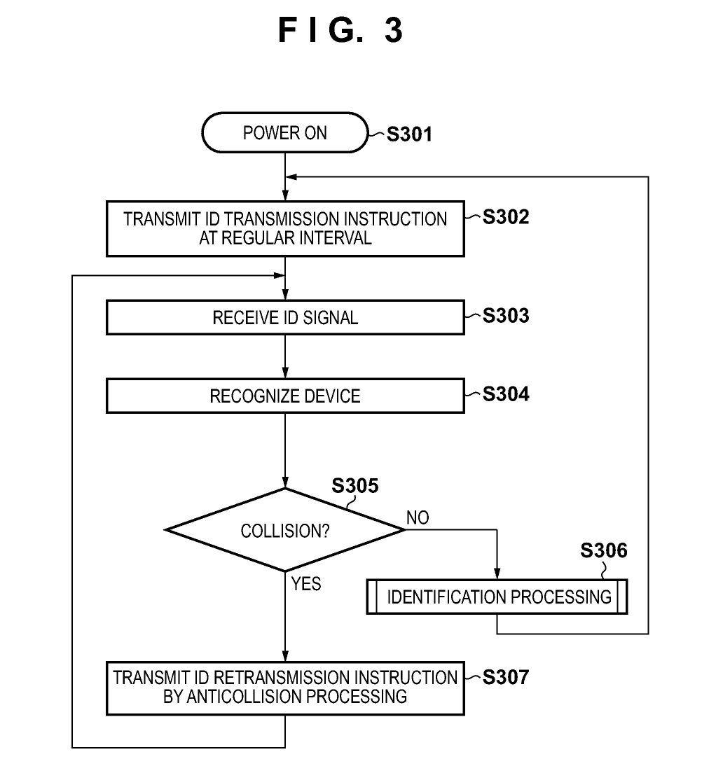

In such a case, excessive power may be supplied to the IC card 201 during a time corresponding to the delay in identifying the IC card 201, and a failure may occur in it. Processing performed by the power supply apparatus 101 according to the first embodiment to prevent such a situation will be explained below with reference to FIGS. 3 to 6.

FIG. 3 is a flowchart showing an example of communication control processing performed by the power supply side microprocessor 108 of the power supply apparatus 101.

When the power supply side microprocessor 108 detects the power-on state of the power supply apparatus 101 in step S301, the process advances from step S301 to step S302. In step S302, the power supply side microprocessor 108 transmits an ID transmission instruction to request transmission of an ID as identification information to a device existing on the power supply apparatus 101 at a regular interval (polling). Note that in step S302, the power supply side microprocessor 108 controls to output the electric energy 103 on which the ID transmission instruction is superposed to the outside as the data 104 from the power supply side.

For example, in the power supply system as shown in FIG. 2A, the power supply side microprocessor 108 controls to transmit the ID transmission instruction to the power receiving apparatus 102 in step S302. In the power supply system shown as in FIG. 2B, the power supply side microprocessor 108 controls to transmit the ID transmission instruction to the power receiving apparatuses 102a and 102b in step S302. In the power supply system shown as in FIG. 2C, the power supply side microprocessor 108 controls to transmit the ID transmission instruction to the IC card 201 in step S302. In the power supply system shown as in FIG. 2D, the power supply side microprocessor 108 controls to transmit the ID transmission instruction to the power receiving apparatus 102 and the IC card 201 in step S302.

When the ID transmission instruction is transmitted, the process advances from step S302 to step S303.

In step S303, the power supply side microprocessor 108 receives a response signal to the ID transmission instruction transmitted in step S302. The response signal to the ID transmission instruction transmitted in step S302 is an ID signal representing the identification information of the device that has received the ID transmission instruction. The power supply side microprocessor 108 stores the received ID information in a memory (not shown). In this case, the process advances from step S303 to step S304.

In step S304, the power supply side microprocessor 108 recognizes the device existing on the power supply apparatus 101 using the ID information received in step S303. When the device existing on the power supply apparatus 101 is recognized, the process advances from step S304 to step S305. In FIG. 2B or 2D, when the processing of step S302 is performed, the plurality of devices existing on the power supply apparatus 101 may simultaneously transmit the ID signals to the power supply apparatus 101. In this case, the power supply apparatus 101 cannot correctly identify the devices using the received ID signals because the ID signals transmitted from the plurality of devices mix. Such mixing of signals transmitted from a plurality of devices is called collusion.

In step S305, the power supply side microprocessor 108 determines whether collision has occurred. When the power supply side microprocessor 108 determines that collision has not occurred (NO in step S305), the process advances from step S305 to step S306. When the power supply side microprocessor 108 determines that collision has occurred (YES in step S305), the process advances from step S305 to step S307.

In step S306, the power supply side microprocessor 108 performs identification processing. Note that the identification processing is processing of identifying what kind of device has been recognized in step S304. Note that the power supply side microprocessor 108 identifies by the identification processing of step S306 whether the device recognized in step S304 is the IC card 201. When the identification processing of step S306 is performed, the process returns from step S306 to step S302. When performing the processing of step S302 after the identification processing of step S306, the ID transmission instruction includes information representing a transmission start time set in step S306.

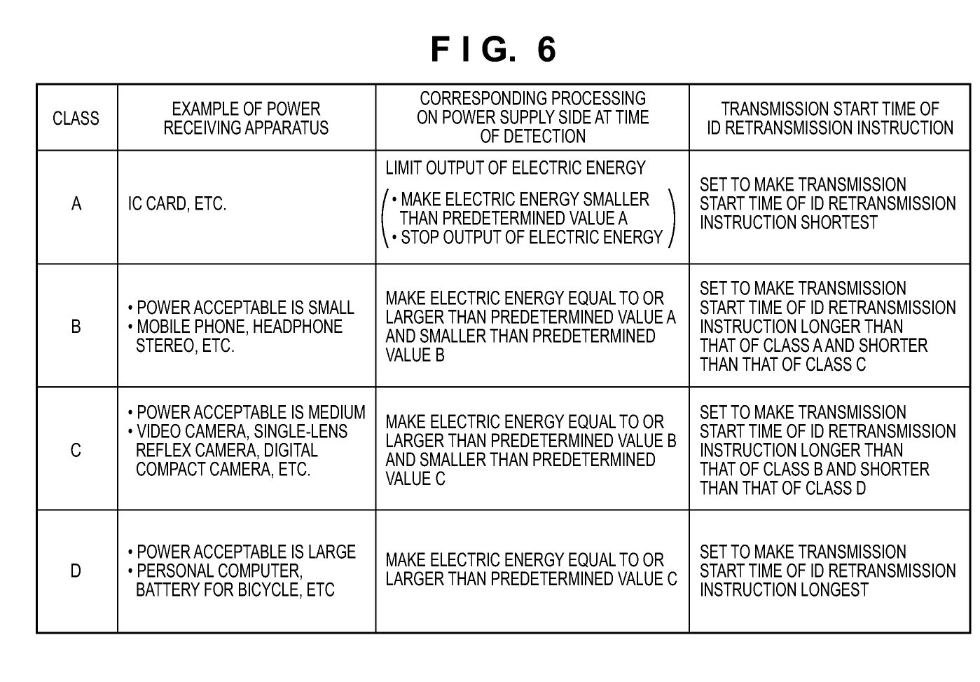

In step S307, the power supply side microprocessor 108 performs anti-collision processing of avoiding collision. The anti-collision processing is processing of, when an ID retransmission instruction is transmitted to a device existing on the power supply apparatus 101, causing the device existing on the power supply apparatus 101 to transmit the ID signal in accordance with the transmission start time set in the identification processing of step S306. The ID retransmission instruction is a signal used to instruct the device existing on the power supply apparatus 101 to retransmit the ID signal. The transmission start time indicates the timing of starting ID signal transmission to the power supply apparatus 101. The transmission start time will be described later with reference to FIG. 6. Note that the ID retransmission instruction includes the information representing the transmission start time set in step S306. Hence, upon receiving the ID retransmission instruction from the power supply apparatus 101, the device existing on the power supply apparatus 101 starts transmitting the ID signal to the power supply apparatus 101 in accordance with the transmission start time included in the ID retransmission instruction. The power supply side microprocessor 108 thus acquires the ID signals while preventing the ID signals transmitted from the devices existing on the power supply apparatus 101 from mixing by the anti-collision processing. When the anti-collision processing is performed, the process returns from step S307 to step S303.

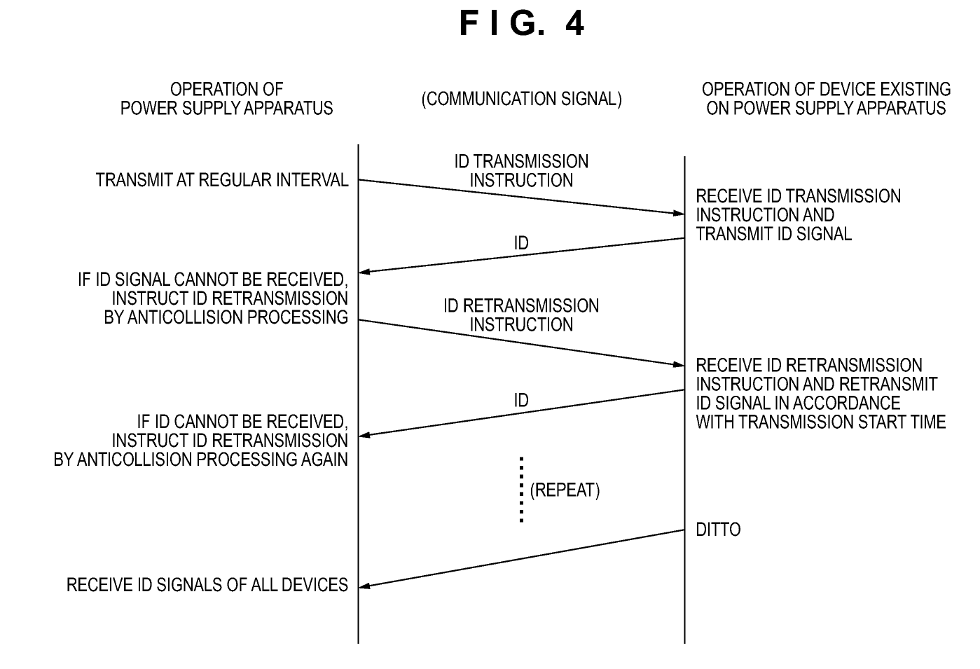

After the anti-collision processing of step S307, the power supply apparatus 101 receives the ID signal from the device existing on it again in step S303, and recognizes the device existing on the power supply apparatus 101 in step S304. Upon determining again that collision has occurred (YES in step S305), the anti-collision processing is performed again in step S307. Note that the power supply apparatus 101 repetitively performs the communication control processing shown in FIG. 3 until all devices existing on the power supply apparatus 101 are identified by ID signals. FIG. 4 shows exchange in communication between the power supply apparatus 101 and a device existing on the power supply apparatus 101 when performing the communication control processing shown in FIG. 3. Upon detecting occurrence of collision at the time of reception of the ID signal, the power supply apparatus 101 transmits the ID retransmission instruction. The power supply apparatus 101 transmits the ID retransmission instruction until the ID signals are received from all devices existing on the power supply apparatus 101 without collision.

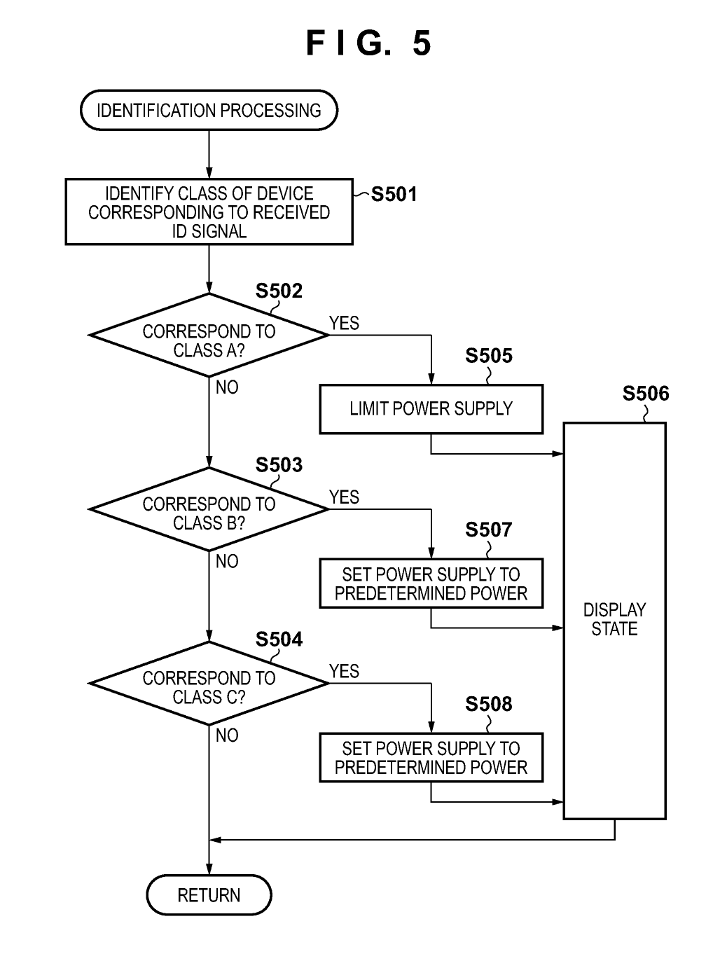

Identification processing performed in step S306 will be described with reference to FIG. 5. Note that FIG. 5 is a flowchart showing an example of identification processing performed by the power supply side microprocessor 108 of the power supply apparatus 101.

In step S501, the power supply side microprocessor 108 determines, using an identification table shown in FIG. 6, to which class the device recognized in step S304 corresponds. For example, using the information included in the ID signal received from the device recognized in step S304 and the identification table shown in FIG. 6, the power supply side microprocessor 108 determines to which class the device recognized in step S304 corresponds. In this case, the power supply side microprocessor 108 records, in the memory (not shown), information representing the class corresponding to the device recognized in step S304. In this case, the process advances from step S501 to step S502. Note that in the identification table in FIG. 6, each class, power acceptable by the power receiving apparatus, processing to be performed by the power supply apparatus 101, and setting of the transmission start time are associated with each other.

In the identification table of FIG. 6, a device of class A corresponds to the IC card 201 and needs to be identified by the power supply apparatus 101 foremost. Hence, the device of class A is set to make the transmission start time shortest. In this case, the device of class A transmits the ID signal that is the identification information of the device of class A to the power supply apparatus 101 after the transmission start time has elapsed from reception of the ID retransmission instruction. The transmission start time corresponding to the device of class A is shorter than any of the transmission start time corresponding to a device of class B, the transmission start time corresponding to a device of class C, and the transmission start time corresponding to a device of class D.

A device of one of class B, class C, and class D does not correspond to the IC card 201 and need not be identified by the power supply apparatus 101 foremost. Hence, the device of one of class B, class C, and class D is set to make the transmission start time longer than the transmission start time of the device of class A not to be identified by the power supply apparatus 101 before the device of class A. In this case, the device of class B transmits the ID signal that is the identification information of the device of class B to the power supply apparatus 101 after the transmission start time has elapsed from reception of the ID retransmission instruction. The transmission start time corresponding to the device of class B is longer than the transmission start time corresponding to the device of class A but shorter than the transmission start time corresponding to the device of class C and the transmission start time corresponding to the device of class D. In this case, the device of class C transmits the ID signal that is the identification information of the device of class C to the power supply apparatus 101 after the transmission start time has elapsed from reception of the ID retransmission instruction. The transmission start time corresponding to the device of class C is longer than the transmission start time corresponding to the device of class A and the transmission start time corresponding to the device of class B but shorter than the transmission start time corresponding to the device of class D. In this case, the device of class D transmits the ID signal that is the identification information of the device of class D to the power supply apparatus 101 after the transmission start time has elapsed from reception of the ID retransmission instruction. The transmission start time corresponding to the device of class D is longer than any of the transmission start time corresponding to the device of class A, the transmission start time corresponding to the device of class B, and the transmission start time corresponding to the device of class C.

In step S502, the power supply side microprocessor 108 determines whether the device recognized in step S304 corresponds to class A. Upon determining that the device recognized in step S304 corresponds to class A (YES in step S502), the power supply side microprocessor 108 determines that the device recognized in step S304 is the IC card 201. In this case (YES in step S502), the process advances from step S502 to step S505. If the power supply side microprocessor 108 determines that the device recognized in step S304 does not correspond to class A (NO in step S502), the process advances from step S502 to step S503.

In step S503, the power supply side microprocessor 108 determines whether the device recognized in step S304 corresponds to class B. Upon determining that the device recognized in step S304 corresponds to class B (YES in step S503), the power supply side microprocessor 108 determines that the device recognized in step S304 is an electronic device that can allow small power. In this case (YES in step S503), the process advances from step S503 to step S507. If the power supply side microprocessor 108 determines that the device recognized in step S304 does not correspond to class B (NO in step S503), the process advances from step S503 to step S504.

In step S504, the power supply side microprocessor 108 determines whether the device recognized in step S304 corresponds to class C. Upon determining that the device recognized in step S304 corresponds to class C (YES in step S504), the power supply side microprocessor 108 determines that the device recognized in step S304 is an electronic device that can allow small power. In this case (YES in step S504), the process advances from step S504 to step S508. If the power supply side microprocessor 108 determines that the device recognized in step S304 does not correspond to class C (NO in step S504), the power supply side microprocessor 108 determines that the device recognized in step S304 corresponds to class D. In this case (NO in step S504), the process returns from step S504 to step S302 of FIG. 3. Note that upon determining that the device recognized in step S304 corresponds to class D, the power supply side microprocessor 108 performs processing of setting the value of the electric energy 103 to a predetermined value C or more before returning to the processing of step S302 in FIG. 3. Note that the predetermined value C is larger than predetermined values A and B to be described later.

In step S505, the power supply side microprocessor 108 performs processing of limiting power supply. In this case, in step S505, the power supply side microprocessor 108 performs processing of making the value of the electric energy 103 output from the power supply apparatus 101 smaller than the predetermined value A. Note that the predetermined value A is equal to or smaller than the electric energy 103 on which the data 104 from the power supply side is superposed. Additionally, in step S505, the power supply side microprocessor 108 can perform processing of stopping the electric energy 103 output from the power supply apparatus 101. When the control to limit power supply is performed, the process advances from step S505 to step S506.

In step S506, the power supply side microprocessor 108 displays information representing the state of the power supply apparatus 101 on an LED (not shown) or a display (not shown) included in the power supply apparatus 101. The information representing the state of the power supply apparatus 101 is, for example, information representing the processing performed by the power supply apparatus 101 before the processing of step S506. For example, when the processing of step S505 has been performed before the processing of step S506, the power supply side microprocessor 108 displays information representing that processing of limiting power supply has been performed on the LED or display (not shown). Note that when one of the processes of steps S507 and S508 has been performed before the processing of step S506 as well, the power supply side microprocessor 108 displays information representing that one of the processes of steps S507 and S508 has been performed on the LED or display (not shown).

Note that in step S506, the power supply side microprocessor 108 may further display information representing to which class the device recognized in step S304 corresponds on the LED or display (not shown).

When the information representing the state of the power supply apparatus 101 is displayed, the process returns from step S506 to step S302 of FIG. 3.

In step S507, the power supply side microprocessor 108 controls to set the electric energy 103 to predetermined power. In this case, the power supply side microprocessor 108 performs processing of making the value of the electric energy 103 equal to or larger than the predetermined value A and smaller than the predetermined value B. Note that the predetermined value B is larger than the predetermined value A and is set in accordance with the power acceptable by the device of class B. In this case, the process advances from step S507 to step S506.

In step S508, the power supply side microprocessor 108 controls to set the electric energy 103 to predetermined power. Note that in this case, the power supply side microprocessor 108 performs processing of making the value of the electric energy 103 equal to or larger than the predetermined value B and smaller than the predetermined value C. Note that the predetermined value C is set in accordance with the power acceptable by the device of class C. In this case, the process advances from step S508 to step S506.

In FIGS. 2C and 2D, the power supply apparatus 101 protects the IC card 201 not to cause a failure in it. However, the present invention is not limited to this. For example, the power supply apparatus 101 may protect not the IC card 201 but an electronic device including no charging function for charging a battery not to cause a failure in it. Alternatively, the power supply apparatus 101 may protect not the IC card 201 but an electronic device including no magnetic loop antenna not to cause a failure in it. Otherwise, the power supply apparatus 101 may protect not the IC card 201 but a metal not to cause a failure such as heat generation in it. Note that a device such as the IC card 201, an electronic device including no charging function, an electronic device including no magnetic loop antenna, or a metal needed to be protected by the power supply apparatus 101 will be referred to as a predetermined device. Note that in this case, when the identification processing of step S306 in FIG. 3 is performed, the power supply apparatus 101 determines that the predetermined device corresponds to class A in the identification table of FIG. 6.

As described above, when the device existing near the power supply apparatus 101 is not the predetermined device, the power supply apparatus 101 according to the first embodiment sets to make the transmission start time corresponding to the device existing near the power supply apparatus 101 longer than the transmission start time corresponding to the predetermined device. For this reason, if the predetermined device and a power receiving apparatus other than the predetermined device exist near the power supply apparatus 101, the power supply apparatus 101 can preferentially identify the predetermined device. Since the predetermined device is thus identified before the power receiving apparatus other than the predetermined device, the power supply apparatus 101 can quickly limit power supply upon identifying the predetermined device. Hence, the power supply apparatus 101 can prevent a failure in the predetermined device by limiting the power to be supplied to the predetermined device not to supply excessive power to it.

In addition, when the predetermined device exists near the power supply apparatus 101, the power supply apparatus 101 according to the first embodiment sets to make the transmission start time corresponding to the predetermined device shorter than the transmission start time corresponding to the power receiving apparatus other than the predetermined device. For this reason, if the predetermined device and the power receiving apparatus other than the predetermined device exist near the power supply apparatus 101, the power supply apparatus 101 can preferentially identify the predetermined device.

Since the predetermined device is thus identified before the power receiving apparatus other than the predetermined device, the power supply apparatus 101 can quickly limit power supply upon identifying the predetermined device. Hence, the power supply apparatus 101 can prevent a failure in the predetermined device by controlling the power to be supplied to the predetermined device not to supply excessive power to it.

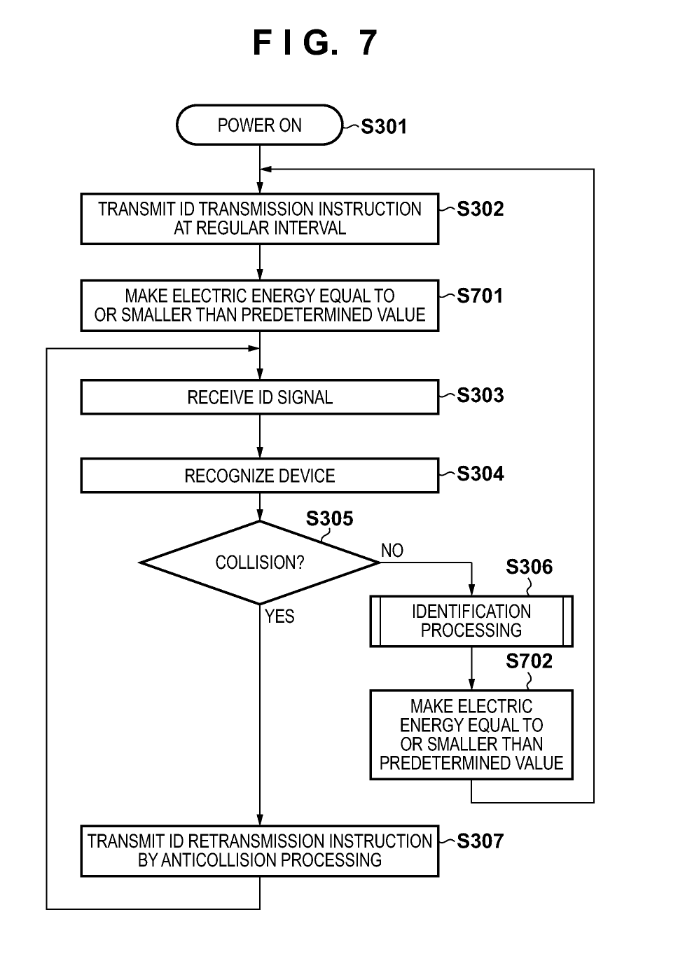

Note that although the power supply apparatus 101 performs the communication control processing shown in FIG. 3 in the first embodiment, communication control processing shown in FIG. 7 may be performed in place of that in FIG. 3.

The communication control processing in FIG. 7 will be described below. Note that as for the communication control processing shown in FIG. 7, a description of the same processes as in the communication control processing of FIG. 3 will be omitted, and processes different from the communication control processing of FIG. 3 will be explained.

When the processing of step S302 is performed, the process advances from step S302 to step S701. In step S701, the power supply side microprocessor 108 controls to make the electric energy 103 output by the power supply apparatus 101 equal to or smaller than a predetermined value. Note that the predetermined value in step S701 is a threshold used to receive the data 105 from the power receiving side from the power receiving apparatus 102. Note that if the output electric energy 103 is larger than the predetermined value in step S701, the power supply apparatus 101 can hardly communicate with the power receiving apparatus 102. If the electric energy 103 is equal to or smaller than the predetermined value in step S701, the power supply apparatus 101 can easily communicate with the power receiving apparatus 102. When control is performed to make the electric energy 103 equal to or smaller than the predetermined value, the process advances from step S701 to step S303.

When the processing of step S306 is performed, the process advances from step S306 to step S702. In step S702, the power supply side microprocessor 108 controls to make the electric energy 103 output by the power supply apparatus 101 equal to or smaller than a predetermined value. Note that the predetermined value in step S702 is a threshold used to transmit the data 104 from the power supply side to the power receiving apparatus 102. Note that if the output electric energy 103 is larger than the predetermined value in step S702, the power supply apparatus 101 can hardly communicate with the power receiving apparatus 102. If the electric energy 103 is equal to or smaller than the predetermined value in step S702, the power supply apparatus 101 can easily communicate with the power receiving apparatus 102. When control is performed to make the electric energy 103 equal to or smaller than the predetermined value, the process returns from step S702 to step S302.

Note that even when the power supply apparatus 101 performs the communication control processing shown in FIG. 7 in place of that in FIG. 3, the same processes have the same effects.

When the communication control processing shown in FIG. 7 is performed, the power supply apparatus 101 controls the electric energy 103 such that it has an appropriate value to transmit the ID transmission instruction and also has an appropriate value to receive the ID signal. This allows the power supply apparatus 101 according to the first embodiment to correctly communicate with the device existing near the power supply apparatus 101.

In the first embodiment, the power supply apparatus 101 and the power receiving apparatus 102 perform communication complying with the NFC standards. However, the present invention is not limited to this. For example, the power supply apparatus 101 and the power receiving apparatus 102 may perform not the communication complying with the NFC standards but communication corresponding to the ISO/IEC 18092 standards such as RFID (Radio Frequency IDentification). Alternatively, the power supply apparatus 101 and the power receiving apparatus 102 may perform not the communication complying with the NFC standards but communication corresponding to the MIFARE® standards. Otherwise, the power supply apparatus 101 and the power receiving apparatus 102 may perform not the communication complying with the NFC standards but communication corresponding to the Felica® standards.

### Other Embodiments

The power supply apparatus according to the present invention is not limited to the power supply apparatus described in the first embodiment. The power supply system according to the present invention is not limited to the power supply system described in the first embodiment. For example, the power supply apparatus according to the present invention may be implemented by a system formed from a plurality of apparatuses.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-007841, filed Jan. 18, 2013, which is hereby incorporated by reference herein in its entirety.

What is claimed is:

1. A power supply apparatus comprising:
a power supply unit configured to wirelessly supply power;
a communication unit configured to transmit a predetermined instruction to request transmission of identification information; and
a control unit configured to, when the predetermined instruction is transmitted to a predetermined device, control to transmit the identification information of the predetermined device to the power supply apparatus after a first time elapses,
wherein when the predetermined instruction is transmitted to a power receiving apparatus different from the predetermined device, the control unit controls to transmit the identification information of the power receiving apparatus to the power supply apparatus after a second time longer than the first time elapses.

2. The apparatus according to claim 1, wherein if the identification information cannot be received from the predetermined device after transmission of the predetermined instruction, the control unit retransmits the predetermined instruction to the predetermined device to start transmission of the identification information in a time shorter than a time in which the power receiving apparatus different from the predetermined device starts transmission.

3. The apparatus according to claim 1, wherein if collision occurs in the power supply apparatus between communication to receive the identification information from the predetermined device and communication to receive the identification information from the power receiving apparatus different from the predetermined device, the control unit retransmits the predetermined instruction such that the time to start transmission of the identification information changes between the predetermined device and the power receiving apparatus different from the predetermined device not to cause collusion.

4. The apparatus according to claim 1, wherein the larger power acceptable by the power receiving apparatus different from the predetermined device is, the longer the control unit sets the time in which transmission of the identification information starts in accordance with the predetermined instruction.

5. The apparatus according to claim 1, wherein the control unit controls power supply to the power receiving apparatus in accordance with power acceptable by the power receiving apparatus corresponding to the identification information received based on the predetermined instruction.

6. The apparatus according to claim 1, wherein after the predetermined instruction is transmitted by the communication unit, the control unit controls to make electric energy to be output from the power supply apparatus smaller than a predetermined value.

7. A power supply system which supplies power to a power receiving apparatus existing near a power supply apparatus,
the power supply apparatus comprising:
a power supply unit configured to wirelessly supply power;
a communication unit configured to transmit a predetermined instruction to request transmission of identification information; and
a control unit configured to, when the predetermined instruction is transmitted to a predetermined device, control to transmit the identification information of the predetermined device to the power supply apparatus after a first time has elapsed,
wherein when the predetermined instruction is transmitted to a power receiving apparatus different from the predetermined device, the control unit controls to transmit the identification information of the power receiving apparatus to the power supply apparatus after a second time longer than the first time has elapsed, and
the power receiving apparatus comprising a communication unit configured to receive the predetermined instruction from the power supply apparatus and transmit the identification information to the power supply apparatus at a timing according to the predetermined instruction.

8. A control method of a power supply apparatus which wirelessly supplies power to a power receiving apparatus, the method comprising:
a communication step of transmitting a predetermined instruction to request the power receiving apparatus to transmit identification information; and
a control step of, when the predetermined instruction is transmitted to a predetermined device, controlling to transmit the identification information of the predetermined device to the power supply apparatus after a first time has elapsed,
wherein when the predetermined instruction is transmitted to a power receiving apparatus different from the predetermined device, control is performed in the control step to transmit the identification information of the power receiving apparatus to the power supply apparatus after a second time longer than the first time has elapsed.

9. A computer-readable storage medium storing a program for causing a computer to execute the control method according to claim 8.
